(19) United States
(12) Patent Application Publication
(10) Pub. No.: US 2003/0023468 A1
(43) Pub. Date: Jan. 30, 2003

(54) Performance indicator and notification system

(76) Inventors: Patrick Aurrichio, Mohegan Lake, NY (US); Wayne S. Balta, Pittsburg, PA (US); Aaron H. Cobb JR., Danbury, CT (US); Edan T. Dionne, Ridgefield, CT (US); Ravi S. Kuchibhotla, Bethel, CT (US); Mitch E. Meyers, Manassas, VA (US); Thomas D. Morris, Scarsdale, NY (US); Carole L. Perrello, Monroe, NY (US); Gayle Woodside, Austin, TX (US)

Correspondence Address: Davidson, Davidson & Kappel, LLC, 485 Seventh Avenue, New York, NY, 10018, US

(21) Appl. No.: 09/918,107

(22) Filed: Jul. 30, 2001

(51) Int. Cl. G06F 17/60

(52) U.S. Cl. 705/7

(57) ABSTRACT

A system and method for monitoring performance information is provided whereby a number of sites are connected to a server via a communications network. An IT tool residing on the server provides forms via which each site submits the performance information to a plurality of databases by an area of interest. As the information is entered, it is monitored for conformance against the pre-established performance criteria set by the program administrator in the system so that at any given time, a report can be generated as a function of currently stored data. Nonconformance is flagged and notification is sent to the appropriate parties in a position to remedy the nonconformance.

### FIELD OF THE INVENTION

This invention relates to a monitoring system and more particularly to a system that monitors business operations performance against pre-established criteria and provides notification when the performance deviates from such criteria.

### BACKGROUND OF THE INVENTION

Over the last several decades there has been increasing focus on environmental protection, and expanding government regulations have made it incumbent upon industry to monitor activities that could affect the environment. In addition to regulatory requirements, companies could establish voluntary metrics as indicators of their environmental performance. As a result, information technology (IT) tools have been developed to gather and process information that affect the environment.

Prior environmental information management systems generally relied on a questionnaire or worksheet to collect information on an as-needed basis in response to a management decision or the request of an external interested party which usually results in emergency information hunts and last-minute “guesstimates.” Since these unplanned information collection requests are oftentimes initiated by pressure from some current environmental concern or crisis, the information provided under such circumstances represents a snap shot of a situation and does not provide for a meaningful performance indicator or for trend analysis. In addition, because an unplanned approach to information gathering is people-dependent, the information is interpreted by both the individuals requesting and reporting the information, leading to inconsistencies.

Moreover with increasing globlization, enterprises need a mechanism for comprehensively and concurrently monitoring their environmental information across all of their sites as well as on a site-by-site basis. To date there has been no system to accommodate such a comprehensive monitoring of environmental performance and notification scheme.

### SUMMARY OF THE INVENTION

The present invention provides a method for monitoring performance information and providing notification when that information indicates performance reaches a certain level. A plurality of forms with instructions that require performance information as a function of uniform data definitions are accepted from multiple sites. After the forms are completed, also known as documents, their information is stored in one or more databases as a function of an area of interest, which could be an environmental medium such as air, water, waste and organized by site, business unit or country, and so on. Information submitted by sites are compared to the pre-established performance criteria stored in the database for determining conformance with such criteria. Any information that does not conform is flagged and a conformance report is generated. Databases may be set up to generate conformance reports either automatically or manually. Additionally, notification is provided to the appropriate parties, such as environmental professionals, when the performance information does not conform with the pre-established performance criteria. Like conformance reports themselves, databases may be set up to send notifications either automatically or manually.

A system implements the preceding method with a processor operably connected to a data storage device. The data storage device further comprises a number of individual storage units, each of the units stores a predetermined type of data by area of interest. An application resides on the data storage device and is executable by the processor to implement the foregoing method by providing the blank forms, accepting the documents and storing the information in its particular storage unit. The program administrators set the performance criteria in the data storage units and the application performs the necessary monitoring, flagging, report generation and notification.

In other embodiments of the present invention, executable computer control process steps operative to control a computer are stored on a computer-readable medium for monitoring performance information in accordance with the method of the present invention.

### BRIEF DESCRIPTION OF THE DRAWINGS

FIG. 1 shows a communications network according to the present invention.

### DETAILED DESCRIPTION OF THE PREFERRED EMBODIMENTS

An information collection and management system, referred to as the Environmental Master Plan, or EMP, is provided with pre-planned reporting requirements that require reporting of specific information at specific times by a predetermined schedule to ensure capturing of key performance indicators and consistency in data reporting by operating as a global application requiring the same data from all reporting locations using the same definitions. In effect, the system provides a central place where consistent global performance information is identified, stored and accessed. The end result is consistent, reliable, and meaningful information for measuring and managing environmental performance to communicate internally, to the public and to governmental agencies, the progress that is made in a broad spectrum of environmental areas across an entire enterprise.

A Performance Indicator and Notification System (PINS) is included in the system to (1) establish performance criteria in a consistent and predetermined manner, and (2) to notify corporate staff and other environmental professionals regarding nonconformance to established performance criteria, as well as flagging these non-conformities in the system databases. In effect, the PINS provides a mechanism for assessing environmental performance on a real-time basis and allowing immediate notification to corporate staff or other environmental professionals when performance data deviates from the established criteria.

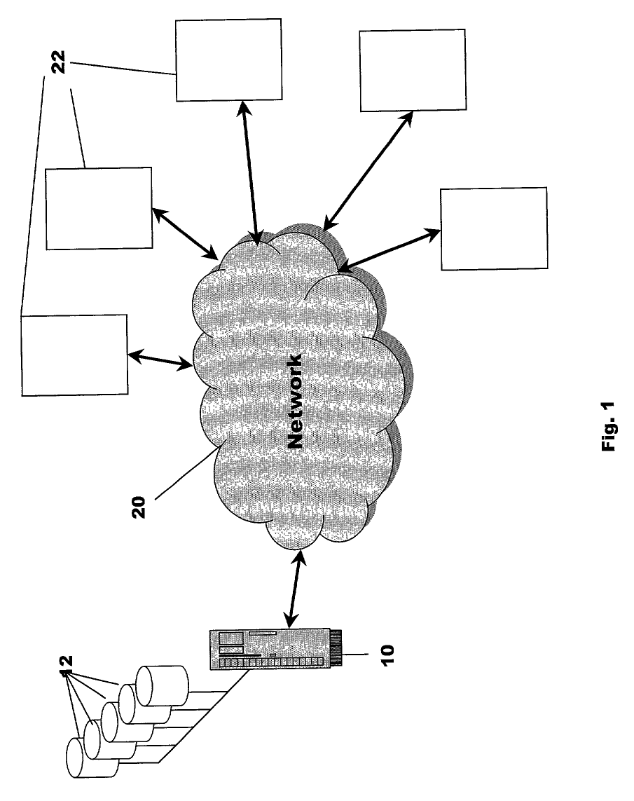

Referring to FIG. 1, there is shown the EMP according to the present invention, preferably implemented as an IT tool residing on a server 10 connected to a communications network 20. The tool is operably connected to a number of databases 12, each one housing information for a distinct area of interest, which may include:

air

water

waste

energy

toxic chemical release inventory

containment

regulatory activity

cost and savings

facility general information

database meta information

health and safety information

materials use and conservation information

Any number of databases may be added to the system to contain any type of information considered pertinent.

A number of sites 22 are connected to the network 20 to communicate with the server 10. The sites 22 may be manufacturing facilities, corporate headquarters, or individual employees conducting environmental field tests to name a few examples. A corresponding client-side tool resides on a computer at each site 22 configured to communicate over the network 20 to provide an interface between users and the system.

A form is used to report performance information from each site 22 and enter it into its corresponding database 12. Instructions and definitions used in completing the form are provided as part of the system so that those completing the forms know exactly what is required, eliminating any guesswork on their part, and those using the information reported in the forms understand it in the correct context. For example, assume there is a toxic chemical release inventory (TCRI) database with a corresponding form that requires the reporting facility to provide data on the annual use of a chemical, the amount of that chemical released into the air, water and land, the amount disposed of off-site, recycled on and off site, treated on and off site, as well as energy recovery on and off-site.

Security in the system is implemented by assigning a specific access level to each user. In a preferred embodiment, there are three levels: reader, author and editor. A reader is limited to viewing documents, which are completed forms, only. An author can view documents, create documents, and modify the documents he or she created. An editor can read, create and modify all documents. As an added security feature, an audit trail is automatically created for each document. At the creation of a document, it is stamped with the name of the author and the creation date. Each time the document is modified, the name of the user that made the modification and the date of the edit are added to the audit trail.

Reported data is aggregated by the EMP and maintained so that information is accessible by any user with proper authorization. Queries can be created to summarize the data and produce useful management information. For example, with reference to the TCRI example discussed earlier, information can be sorted by geography, country and sites, allowing a reviewer to compare performance among geographical areas, countries and sites. Alternatively, the information can be sorted by a specific chemical to study a chemical's use rate and disposition across a company.

The PINS electronically enables data limits within the EMP by applying a high or low limit to information in the system databases. Depending on several factors, including the EMP database design, established environmental goals and measurement period, the limit of a certain criterion is set as a “high” or “low” limit. Performance results and the pre-established limit are compared and a determination is made whether the performance data exceeds or falls short of the limit, whichever applies. Any data exceeding or falling below a limit will cause that information to be flagged and a notification sent to the appropriate parties, such as environmental managers and professionals, by an electronic communication system linked to the EMP databases, like an e-mail system. In this way, performance is monitored in real-time and notification is provided substantially concurrently for sub-par performance. Additionally, reports generated by the system reflect all the stored information at the time the report is generated. This allows any site with sub-par performance to learn the impact of an individual location on overall company performance. Further, if a user at one site were to input data that exceeds a company-wide limit, it will trigger notification to all sites.

To illustrate the possibilities of the database configuration, consider the following, as examples:

Air Programs Database—an air emissions “high” limit can be set at a specified emission level for a particular chemical for the current year.

Waste Management Database—a “low” linit can be set for recycling quantities or percentage rates of nonhazardous and hazardous waste for a given time period, such as a quarter.

Energy database—a “high” limit could be set at a level when submitted data shows that energy consumption has surpassed the previous year's use for the same time period. Likewise, a “low” limit could be set at a level when data provided show that energy conservation savings is below a site's current year plan.

Cost and Savings Database—a “low” limit could be set for a ratio indicating the savings of current operations versus the savings over some past time period to ensure that economic efficiency does not fall below a predetermined level.

In this way, performance data criteria may be set at a global, regional or site level. This flexible system for setting performance levels allows for site-specific criteria to be set for a facility while corporate-wide criteria to be set for goals affecting all or some locations.

Further functions of the PINS are:

Control documents—created with instructions for use by authorized users to set performance criteria in the EMP databases.

Performance Indicator Report—the application compares the submitted data against the predetermined criteria at a pre-established review period (e.g., monthly, quarterly) and automatically generates a nonconformance report in accordance to the database design. Moreover, a software agent would be created to allow manual generation of a report. Under this scheme, an authorized user can activate the agent as required to manually generate desired reports.

Notification—based on the Performance Indicator Report and where nonconformance exists, notification is sent to the appropriate persons, alerting the person to review the particular nonconformity. Notification may be sent by any method suitable to provide the necessary information to the appropriate parties. For example, e-mail sent over the communication network, a voice mail message, or text message displayed on an alphanumeric pager.

Flagging—nonconformance entries into their respective databases are flagged so that users can view the current status of environmental performance data against the performance criteria. Flagging may be done a number of ways, depending on the database design. For example, a nonconformity view for each database can be provided which lists all nonconformity data for a specific database by some criteria, such as geography or site.

Security is extended from the EMP to the PINS by only allowing authorized users, such as those assigned editor status, to establish limits. The audit trails will be updated whenever an access occurs by adding the person's name along with the time and date of the access into the audit file.

In effect, the PINS provides a data collection tool with a feedback mechanism enabling locations to make use of the input to improve performance immediately, before the end of a measurement period. PINS provides real-time analysis of performance data, as opposed to a retrospective view on performance passed the elapsed measurement period so that comprehensive company-wide monitoring of performance is accomplished in a manner such that data entered in a single site is accessible, in real-time, at other sites to perform thresholding on limits set at multiple sites, all sites, or just the local site. PINS makes the entire process of performance tracking against criteria systematic, timely and efficient; and turns lagging indicators into leading indicators by way of providing real-time performance feedback. Further, PINS allows for effective comparisons of present environmental performance data with proposed regulation. Should a governmental agency propose a new regulation or environmental limit, setting the new limit in the PINS allows the company to see the impact on a specific site, region or the entire company. The new regulation will cause modified performance criteria and the system may be configured to review the previously entered information in the databases for all non-conformities that may result.

What is claimed is:

1. A method for monitoring performance information and providing notification when the performance information indicates performance reaching a predetermined level, the method comprising the steps of:
a program administrator setting performance criteria in a system;
the system accepting a plurality of forms from a plurality of sites, each of the forms including performance information as a function of uniform data definitions;
the system storing the performance information in a database as a function of an area of interest of the performance information;
the system monitoring the performance information for conformance with the performance criteria as it is stored and flagging the performance information that does not conform with the performance criteria so that a report can be generated, either automatically or manually, as a function of at least a portion of the currently stored performance information;
the system providing notification when the performance information deviates from the performance criteria.

2. The method of claim 1 further comprising monitoring the currently stored performance information of a specific set of sites for conformance with site-specific performance criteria.

3. The method of claim 2 wherein the set of sites is a single site and the site-specific performance criteria comprises the performance criteria for the single site.

4. The method of claim 2 wherein the set of sites comprises multiple sites and the site-specific performance criteria comprises the performance criteria for the multiple sites.

5. The method of claim 2 wherein the set of sites comprises all sites and the site-specific performance criteria comprises the performance criteria for the all sites.

6. The method of claim 1 wherein the step of providing notification further comprises sending notification via one or more of:
e-mail;
telephone;
facsimile;
pager; and,
postal mail.

7. The method of claim 1 wherein the step of providing notification further comprises providing notification to an environmental professional.

8 The method of claim 1 further comprising the steps of:
modifying performance criteria;
reviewing data in the database for nonconformance with the modified performance criteria;
providing notification of nonconformance with the modified performance criteria.

9. The method of claim 1 wherein the areas of interest include one or more of:
air;
water;
waste;
energy;
toxic chemical release inventory;
containment;
regulatory activity;
cost and savings;
facility general information;
database meta information;
health and safety information; and,
materials use and conservation information.

10. The method of claim 1 wherein the particular database is an Air Programs Database and the performance criteria is a high limit on emissions level.

11. The method of claim 1 wherein the particular database is a Waste Management Database and the performance criteria is a low limit on recycling quantities and percentage rates of nonhazardous and hazardous waste.

12. The method of claim 1 wherein the particular database is an Energy Database and the performance criteria is a high limit on energy consumption.

13. The method of claim 1 wherein the particular database is a Cost and Savings Database and the performance criteria is a low limit on cost to savings ratio to ensure that economic efficiency does not fall below a predetermined level.

14. The method of claim 1 further comprising the step of generating a summary report at a pre-established review period, the report comprising a comparison of the performance information to the pre-established performance criteria in the system.

15. The method of claim 1 further comprising the step of assigning a specific access level to a user, the access level further comprising:
reader;
author; and,
editor;
wherein the reader is limited to viewing documents, the author can view documents, create documents, and modify documents created by the author, and the editor can read, create and modify all documents.

16. The method of claim 1 further comprising the step of automatically creating an audit trail to the forms, the audit trail comprising:
a name of an author;
a creation date;
a name of a modifying user; and,
a date of modification.

17. The method of claim 1 further comprising the step of creating queries to summarize data and produce useful management information.

18. The method of claim 17 wherein the creating step further comprises sorting by a specific chemical to study a chemical's use rate and disposition across an operation.

19. A system for monitoring performance information comprising:
a processor;
a data storage device operably connected to the processor, the data storage device further comprising a number of individual storage units for storing a predetermined type of data;
a program executable by the processor to:
accept a plurality of forms from a plurality of sites, each of the forms including performance information as a function of uniform data definitions;
store the performance information in a database as a function of an area of interest of the performance information;
monitor the performance information as it is stored for conformance against pre-established performance criteria set by a program administrator and flag the performance information that does not conform with the performance criteria so that a report can be generated, either automatically or manually, as a function of at least a portion of the currently stored performance information in the plurality of databases;
provide notification when the performance information deviates from the performance criteria.

20. The system of claim 19 wherein the program is further executable to monitor the currently stored performance information of a specific set of sites for conformance with site-specific performance criteria.

21. The system of claim 20 wherein the set of sites comprises a single site and the site-specific performance criteria comprises the performance criteria for the single site.

22. The system of claim 20 wherein the set of sites comprises multiple sites and the site-specific criteria comprises the performance criteria for the multiple sites.

23. The system of claim 20 wherein the set of sites comprises all sites and the site-specific criteria comprises the performance criteria for the all sites.

24. The system of claim 19 wherein the program is further executable to send notification via one or more of:
e-mail;
telephone;
facsimile;
pager; and,
postal mail.

25. The system of claim 19 wherein the program is further executable to provide notification to an environmental professional.

26. The system of claim 19 wherein the program is further executable to:
modify performance criteria;
review data in the database for nonconformance with the modified performance criteria;
provide notification of nonconformance with the modified performance criteria.

28. The system of claim 19 wherein the areas of interest include one or more of:
air;
water;
waste;
energy;
toxic chemical release inventory;
containment;
regulatory activity;
cost and savings;
facility general information;
database meta information;
health and safety information; and,
materials use and conservation information.

29. The system of claim 19 wherein the particular database is an Air Programs Database and the performance criteria is a high limit on emissions level.

30. The system of claim 19 wherein the particular database is a Waste Management Database and the performance criteria is a low limit on recycling quantities and percentage rates of nonhazardous and hazardous waste.

31. The system of claim 19 wherein the particular database is an Energy Database and the performance criteria is a high limit on energy consumption.

32. The system of claim 19 wherein the particular database is a Cost and Savings Database and the performance criteria is a low limit on cost to savings ratio to ensure that economic efficiency does not fall below a predetermined level.

33. The system of claim 19 further comprising the step of generating a summary report at a pre-established review period, the report comprising a comparison of the performance information to the pre-established performance criteria set by the program administrator in the system.

34. The system of claim 19 further comprising a number of specific access levels for a user, the access levels further comprising:
reader;
author; and,
editor;
wherein the reader is limited to viewing documents, the author can view documents, create documents, and modify documents created by the author, and the editor can read, create and modify all documents.

35. The system of claim 19 further comprising an automatically created audit trail for the forms, the audit trail comprising:
a name of an author;
a creation date;
a name of a modifying user; and,
a date of modification.

36. The system of claim 19 further comprising queries to summarize data and produce useful management information.

37. The system of claim 19 wherein the queries further comprise sorting by a specific chemical to study a cheniical's use rate and disposition across an operation.

38. Computer executable process steps operative to control a computer, stored on a computer readable medium, for monitoring performance information comprising the steps of:
accepting a plurality of forms from a plurality of sites, each of the forms including performance information as a function of uniform data definitions;
storing the performance information in a database as a function of an area of interest of the performance information;
monitoring the performance information as it is stored for conformance against pre-established performance criteria set by a program administrator and flagging the performance information that does not conform with the performance criteria so that a report can be generated, either automatically or manually, as a function of at least a portion of the currently stored performance information in the plurality of databases;
providing notification when the performance information deviates from the performance criteria.

39. The computer executable process steps of claim 38 further comprising monitoring the currently stored performance information of a specific set of sites for conformance with site-specific performance criteria.

40. The computer executable process steps of claim 39 wherein the set of sites is a single site and the site-specific performance criteria comprises the performance criteria for the single site.

41. The computer executable process steps of claim 39 wherein the set of sites comprises multiple sites and the site-specific performance criteria comprises the performance criteria for the multiple sites.

42. The computer executable process steps of claim 39 wherein the set of sites comprises all sites and the site-specific criteria comprises the performance criteria for the all sites.

43. The computer executable process steps of claim 38 wherein the step of providing notification further comprises sending notification via one or more of:
e-mail;
telephone;
facsimile;
pager; and,
postal mail.

44. The computer executable process steps of claim 38 wherein the step of providing notification further comprises providing notification to an environmental professional.

45. The computer executable process steps of claim 38 further comprising the steps of:
modifying performance criteria;
reviewing data in the one or more databases for nonconformance with the modified performance criteria;
providing notification of nonconformance with the modified performance criteria.

46. The computer executable process steps of claim 38 wherein the areas of interest include one or more of:
air;
water;
waste;
energy;
toxic chemical release inventory;
containment;
regulatory activity;
cost and savings;
facility general information;
database meta information;
health and safety information; and,
materials use and conservation information.

47. The computer executable process steps of claim 38 wherein the particular database is an Air Programs Database and the performance criteria is a high limit on emissions level.

48. The computer executable process steps of claim 38 wherein the particular database is a Waste Management Database and the performance criteria is a low limit on recycling quantities and percentage rates of nonhazardous and hazardous waste.

49. The computer executable process steps of claim 38 wherein the particular database is an Energy Database and the performance criteria is a high limit on energy consumption.

50. The computer executable process steps of claim 38 wherein the particular database is a Cost and Savings Database and the performance criteria is a low limit on cost to savings ratio to ensure that economic efficiency does not fall below a predetermined level.

51. The computer executable process steps of claim 38 further comprising the step of generating a summary report at a pre-established review period, the report comprising a comparison of the performance information to the pre-established performance criteria set by the program administrator.

52. The computer executable process steps of claim 38 further comprising the step of assigning a specific access level to a user, the access level further comprising:
reader;
author; and,
editor;
wherein the reader is limited to viewing documents, the author can view documents, create documents, and modify documents created by the author, and the editor can read, create and modify all documents.

53. The computer executable process steps of claim 38 further comprising the step of automatically creating an audit trail to the forms, the audit trail comprising:
a name of an author;
a creation date;
a name of a modifying user; and,
a date of modification.

54. The computer executable process steps of claim 38 further comprising the step of creating queries to summarize data and produce useful management information.

55. The computer executable process steps of claim 38 wherein the creating step further comprises sorting by a specific chemical to study a chemical's use rate and disposition across an operation.
